(19) United States
(12) Patent Application Publication
(10) Pub. No.: US 2016/0026675 A1
(43) Pub. Date: Jan. 28, 2016

(54) DATA PROCESSING METHOD, COORDINATOR, AND NODE DEVICE

(71) Applicant: Huawei Technologies Co., Ltd., Shenzhen (CN)

(72) Inventors: Pei LIU, Beijing (CN); Yibo WANG, Beijing (CN); Weixia ZOU, Beijing (CN)

(21) Appl. No.: 14/866,384

(22) Filed: Sep. 25, 2015

Related U.S. Application Data
(63) Continuation of application No. PCT/CN2014/074317, filed on Mar. 28, 2014.

(30) Foreign Application Priority Data
Mar. 28, 2013 (CN) 201310104795.6

(51) Int. Cl. G06F 17/30

(52) U.S. Cl. CPC G06F 17/30371

(57) ABSTRACT

Embodiments of the present invention provide a data processing method, a coordinator, and a node device. The coordinator receives a data frame sent by the node device, where the data frame includes service data; the coordinator determines whether the service data is within a set data confidence interval; and if the coordinator determines that the service data is beyond the data confidence interval, the coordinator sends a questioned-data frame to the node device, where the questioned-data frame carries the service data, so that the node device confirms correctness of the service data.

### CROSS-REFERENCE TO RELATED APPLICATIONS

This application is a continuation of International Patent Application No. PCT/CN2014/074317, filed on Mar. 28, 2014, which claims priority to Chinese Patent Application No. 201310104795.6, filed on Mar. 28, 2013, both of which are hereby incorporated by reference in their entireties.

### TECHNICAL FIELD

Embodiments of the present invention relate to communications technologies, and in particular, to a data processing method, a coordinator, and a node device.

### BACKGROUND

A main function of a wireless sensor network, such as a wireless intelligent meter reading system, based on a wireless personal area network (Wireless Personal Area Network, WPAN for short) transmission technology, is collecting data on usage of factories and households in terms of water, electricity, gas, heat, and the like and performing a related charging operation on a basis of this data and other auxiliary information.

In the prior art, a node device on a wireless personal area network generally adds data to a data frame, and sends the data frame to a coordinator of the wireless personal area network, and after receiving the data frame carrying the data, the coordinator returns, to the node device, a confirmation frame to confirm success in receiving.

However, in the prior art, if there is an error in data sent by a node device to a coordinator, requirements of a system on data reliability and accuracy cannot be met.

### SUMMARY

Embodiments of the present invention provide a data processing method, a coordinator, and a node device, so as to improve data reliability and accuracy.

With reference to a first aspect, an embodiment of the present invention provides a data processing method, including:

receiving, by a coordinator, a data frame sent by a node device, where the data frame includes service data; and

determining, by the coordinator, whether the service data is within a set data confidence interval; and if the coordinator determines that the service data is beyond the data confidence interval, sending, by the coordinator, a questioned-data frame to the node device, where the questioned-data frame carries the service data, so that the node device confirms correctness of the service data.

In a first possible implementation manner of the first aspect, before the determining, by the coordinator, whether the service data is within a set data confidence interval, the method further includes: determining, by the coordinator, the data confidence interval according to historical data having a service type the same as a service type of the service data.

According to the first possible implementation manner of the first aspect, in a second possible implementation manner of the first aspect, the determining, by the coordinator, the data confidence interval according to historical data having a service type the same as a service type of the service data includes: extracting, by the coordinator, multiple pieces of historical data, corresponding to a transmission moment in a transmission cycle in which the service data is, within multiple historical transmission cycles preceding the transmission cycle in which the service data is; and determining, by the coordinator, the data confidence interval according to [X−a×σ,X+a×σ], where X is a mean of the multiple pieces of historical data, σ is a standard deviation of the multiple pieces of historical data, and a is a tolerance coefficient.

With reference to the first aspect or either of the foregoing two possible implementation manners of the first aspect, in a third possible implementation manner of the first aspect, after the sending, by the coordinator, a questioned-data frame to the node device, the method further includes: receiving, by the coordinator, a data questioning rejected confirmation frame sent by the node device, where the data questioning rejected confirmation frame is used for indicating that the service data is correct; or receiving, by the coordinator, a data questioning accepted confirmation frame sent by the node device, where the data questioning accepted confirmation frame is used for indicating that the service data is erroneous; and receiving, by the coordinator, an updated data frame sent by the node device, where the updated data frame includes updated service data.

According to a second aspect, an embodiment of the present invention provides another data processing method, including:

acquiring, by a node device, service data; sending, by the node device, a data frame to a coordinator, where the data frame includes the service data, so that the coordinator determines whether the service data is within a data confidence interval; receiving, by the node device, a questioned-data frame sent by the coordinator, where the questioned-data frame carries the service data; and confirming, by the node device, correctness of the service data.

In a first possible implementation manner of the second aspect, the confirming, by the node device, correctness of the service data includes: determining, by the node device by means of comparison, whether the service data in the questioned-data frame is the same as the service data in the data frame sent to the coordinator; and if the service data in the questioned-data frame is different from the service data in the data frame sent to the coordinator, resending the service data to the coordinator; or if the service data in the questioned-data frame is the same as the service data in the data frame sent to the coordinator, verifying, with a service data sensing apparatus, the correctness of the service data.

According to a third aspect, an embodiment of the present invention provides a coordinator, including:

a receiving module, configured to receive a data frame sent by a node device, where the data frame includes service data; a judging module, configured to determine whether the service data is within a set data confidence interval; and a sending module, configured to send, after the judging module determines that the service data is beyond the data confidence interval, a questioned-data frame to the node device, where the questioned-data frame carries the service data, so that the node device confirms correctness of the service data.

In a first possible implementation manner of the third aspect, the coordinator further includes: a determining module, configured to determine the data confidence interval according to historical data having a service type the same as a service type of the service data.

With reference to the first possible implementation manner of the third aspect, in a second possible implementation manner of the third aspect, the determining module is specifically configured to: extract multiple pieces of historical data, corresponding to a transmission moment in a transmission cycle in which the service data is, within multiple historical transmission cycles preceding the transmission cycle in which the service data is; and determine the data confidence interval according to [X−a×σ,X+a×σ], where X is a mean of the multiple pieces of historical data, σ is a standard deviation of the multiple pieces of historical data, and a is a tolerance coefficient.

With reference to the third aspect or either of the foregoing two possible implementation manners of the third aspect, in a third possible implementation manner of the third aspect, the receiving module is further configured to: receive a data questioning rejected confirmation frame sent by the node device, where the data questioning rejected confirmation frame is used for indicating that the service data is correct; or receive a data questioning accepted confirmation frame sent by the node device, where the data questioning accepted confirmation frame is used for indicating that the service data is erroneous; and receive, an updated data frame sent by the node device, where the updated data frame includes updated service data.

According to a fourth aspect, an embodiment of the present invention provides a node device, including:

an acquiring module, configured to acquire service data; a sending module, configured to send a data frame to a coordinator, where the data frame includes the service data, so that the coordinator determines whether the service data is within a data confidence interval; a receiving module, configured to receive a questioned-data frame sent by the coordinator, where the questioned-data frame carries the service data; and a confirmation module, configured to confirm correctness of the service data.

In a first possible implementation manner of the fourth aspect, the confirmation module is specifically configured to: determine, by means of comparison, whether the service data in the questioned-data frame is the same as the service data in the data frame sent to the coordinator; and if the service data in the questioned-data frame is different from the service data in the data frame sent to the coordinator, resend the service data to the coordinator; or if the service data in the questioned-data frame is the same as the service data in the data frame sent to the coordinator, verify, with a service data sensing apparatus, the correctness of the service data.

According to the data processing method, the coordinator, and the node device that are provided in the embodiments of the present invention, the coordinator first determines whether received service data is within a data confidence interval; and if the service data is beyond the data confidence interval, returns the service data to the node device for confirmation. Compared with a manner in the prior art in which a coordinator directly accepts service data, the data processing method provided in the embodiments of the present invention meets requirements of a system on data reliability and accuracy.

### BRIEF DESCRIPTION OF DRAWINGS

To describe the technical solutions in the embodiments of the present invention more clearly, the following briefly introduces the accompanying drawings required for describing the embodiments. Apparently, the accompanying drawings in the following description show some embodiments of the present invention, and persons of ordinary skill in the art may still derive other drawings from these accompanying drawings without creative efforts.

FIG. 1 is a flowchart of Embodiment 1 of a data processing method according to the present invention;

FIG. 2 is a flowchart of Embodiment 2 of a data processing method according to the present invention;

FIG. 3 is a flowchart of Embodiment 3 of a data processing method according to the present invention;

FIG. 4 is a signaling flowchart of Embodiment 4 of a data processing method according to the present invention;

FIG. 5A and FIG. 5B are an overall flowchart of Embodiment 5 of a data processing method according to the present invention;

FIG. 6 is a schematic structural diagram of Embodiment 1 of a coordinator according to the present invention;

FIG. 7 is a schematic structural diagram of Embodiment 2 of a coordinator according to the present invention;

FIG. 8 is a schematic structural diagram of Embodiment 1 of a node device according to the present invention;

FIG. 9 is a schematic structural diagram of Embodiment 3 of a coordinator according to the present invention; and

FIG. 10 is a schematic structural diagram of Embodiment 2 of a node device according to the present invention.

### DESCRIPTION OF EMBODIMENTS

To make the objectives, technical solutions, and advantages of the embodiments of the present invention clearer, the following clearly describes the technical solutions in the embodiments of the present invention with reference to the accompanying drawings in the embodiments of the present invention. Apparently, the described embodiments are some but not all of the embodiments of the present invention. All other embodiments obtained by persons of ordinary skill in the art based on the embodiments of the present invention without creative efforts shall fall within the protection scope of the present invention.

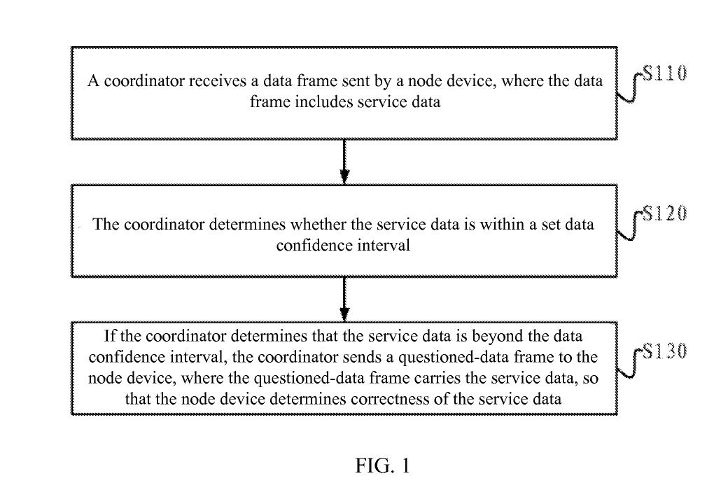

FIG. 1 is a flowchart of Embodiment 1 of a data processing method according to the present invention. As shown in FIG. 1, the data processing method provided in this embodiment may include:

S110: A coordinator receives a data frame sent by a node device, where the data frame includes service data.

Specifically, the service data specifically may be data on household water consumption, household power consumption, or the like, the service data may be acquired and provided for the node device by a data sensing apparatus, and the node device adds the service data to the data frame, and sends the data frame to the coordinator. After receiving the data frame sent by the node device, the coordinator may return a common confirmation frame to the node device to indicate that the data frame has been received.

S120: The coordinator determines whether the service data is within a set data confidence interval.

The data confidence interval may be a fixed interval preset in the coordinator, and for example, is provided by a service operator or a personal area network manager. The data confidence interval may also be dynamically set by the coordinator according to historical data or another influence factor each time after the coordinator acquires service data.

S130: If the coordinator determines that the service data is beyond the data confidence interval, the coordinator sends a questioned-data frame to the node device, where the questioned-data frame carries the service data, so that the node device confirms correctness of the service data.

If the coordinator determines that the service data is beyond the data confidence interval, the coordinator does not directly accept the service data, but may add the service data to the questioned-data frame, and send the questioned-data frame to the node device, so that the node device confirms the service data.

According to the data processing method provided in this embodiment, a coordinator first determines whether received service data is within a data confidence interval, and if the service data is beyond the data confidence interval, returns the service data to a node device for confirmation. Compared with a manner in the prior art in which a coordinator directly accepts service data, the data processing method provided in this embodiment of the present invention meets requirements of a system on data reliability and accuracy.

Further, before the determining, by the coordinator, whether the service data is within a set data confidence interval, the method further includes: determining, by the coordinator, the data confidence interval according to historical data having a service type the same as a service type of the service data.

The determining, by the coordinator, the data confidence interval according to historical data having a service type the same as a service type of the service data includes: extracting, by the coordinator, multiple pieces of historical data, corresponding to a transmission moment in a transmission cycle in which the service data is, within multiple historical transmission cycles preceding the transmission cycle in which the service data is; and determining, by the coordinator, the data confidence interval according to [X−a×σ,X+a×σ], where X is a mean of the multiple pieces of historical data, σ is a standard deviation of the multiple pieces of historical data, and a is a tolerance coefficient.

Specifically, the method for the determining, by the coordinator, the data confidence interval according to historical data having a service type the same as a service type of the service data may include:

assuming that a transmission cycle for transmission data of the node device is set to T, receiving, by the coordinator within the n^{th} transmission cycle, m pieces of service data, which are X_{n,1}, X_{n,2}, . . . , X_{n,m-1}, and X_{n,m}, separately sent by the node device at m moments; and assuming that the coordinator receives a piece of new service data X_{n+1,m} at the m^{th} moment of the (n+1)^{th} transmission cycle, extracting, by the coordinator, n pieces of service data, which are X_{1,m}, X_{2,m}, . . . , X_{n-1,m}, and X_{n,m}, sent by the node device at the m^{th} moments of previous n transmission cycles, where a mean of the n pieces of data is X=(Σᵢ₌₁ⁿX_{i,m})/n, and a standard deviation of the n pieces of data is σ=\sqrt{[Σᵢ₌₁ⁿ(X_{i,m}−X)²]/n}.

A data confidence interval of the service data X_{n+1,m} may be determined as [X−a×σ,X+a×σ], where the tolerance coefficient a is a positive integer and may be determined according to a degree of tolerance of a system for the service data deviation mean X. A larger value of a results in a higher probability that the service data X_{n+1,m} falls within the data confidence interval.

One manner of dynamically determining the data confidence interval of the service data is described above, and certainly, the data confidence interval of the service data may also be determined in another manner, for example, a mean X1 of all pieces of historical data having a service type the same as a service type of the service data is determined, and then, the data confidence interval of the service data is determined as [X1−0.2X1,X1+0.2X1]. In this embodiment of the present invention, a specific manner of determining the data confidence interval of the service data is not limited.

Further, after the coordinator sends the questioned-data frame to the node device, the method further includes: receiving, by the coordinator, a data questioning rejected confirmation frame sent by the node device, where the data questioning rejected confirmation frame is used for indicating that the service data is correct; or receiving, by the coordinator, a data questioning accepted confirmation frame sent by the node device, where the data questioning accepted confirmation frame is used for indicating that the service data is erroneous; and receiving, by the coordinator, an updated data frame sent by the node device, where the updated data frame includes updated service data.

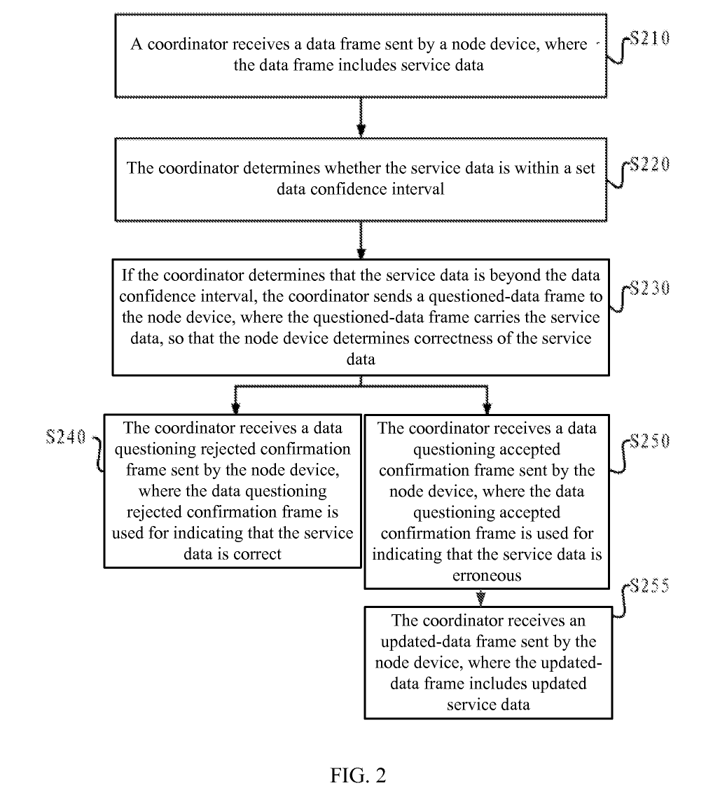

FIG. 2 is a flowchart of Embodiment 2 of a data processing method according to the present invention. As shown in FIG. 2, the data processing method provided in this embodiment may include:

S210 to S230 similar to S110 to S130 in the embodiment shown in FIG. 1 are not repeatedly described herein.

S240: The coordinator receives a data questioning rejected confirmation frame sent by the node device, where the data questioning rejected confirmation frame is used for indicating that the service data is correct.

After the coordinator sends the questioned-data frame to the node device, the node device sends the data questioning rejected confirmation frame to the coordinator if the node device confirms that the service data is correct; and after receiving the data questioning rejected confirmation frame, the coordinator accepts the service data, and returns a data accepted confirmation frame to the node device.

S250: The coordinator receives a data questioning accepted confirmation frame sent by the node device, where the data questioning accepted confirmation frame is used for indicating that the service data is erroneous.

After the coordinator sends the questioned-data frame to the node device, the node device sends the data questioning accepted confirmation frame to the coordinator if the node device verifies that the service data is erroneous.

S255: The coordinator receives an updated data frame sent by the node device, where the updated data frame includes updated service data.

After verifying that the service data is erroneous, the node device re-acquires the updated service data, adds the updated service data to the updated data frame, and sends the updated data frame to the coordinator. After receiving the updated service data, the coordinator still processes the updated service data by means of S220 and the subsequent steps.

According to the data processing method provided in this embodiment, a coordinator may determine a data confidence interval of service data dynamically according to historical data, determine whether the service data is within the data confidence interval, and if the service data is beyond the data confidence interval, return the service data to a node device for confirmation. Compared with a manner in the prior art in which a coordinator directly accepts service data, the data processing method provided in this embodiment of the present invention meets requirements of a system on data reliability and accuracy.

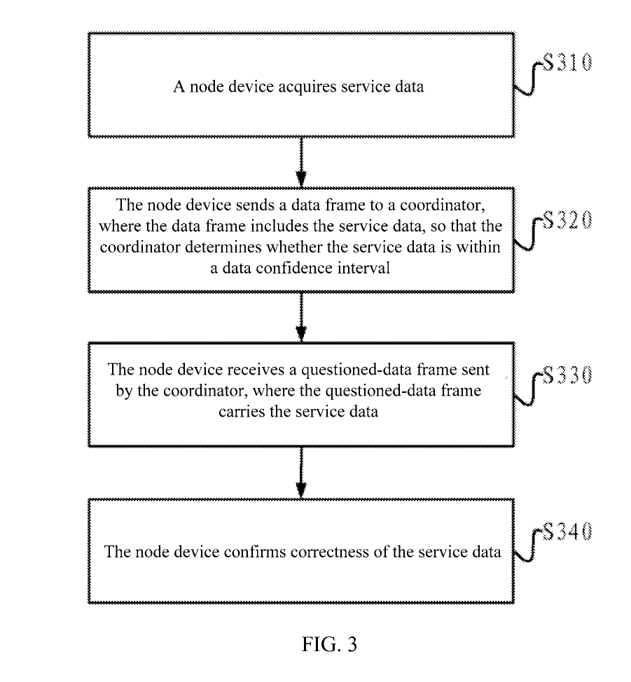

FIG. 3 is a flowchart of Embodiment 3 of a data processing method according to the present invention. As shown in FIG. 3, the data processing method provided in this embodiment may include:

S310: A node device acquires service data.

The service data specifically may be data on household water consumption, household power consumption, or the like, and the service data may be acquired and provided for the node device by a data sensing apparatus.

S320: The node device sends a data frame to a coordinator, where the data frame includes the service data, so that the coordinator determines whether the service data is within a data confidence interval.

The node device then adds the service data to the data frame, and sends the data frame to the coordinator. After receiving the data frame sent by the node device, the coordinator may return a common confirmation frame to the coordinator to indicate that the data frame has been received. A manner of determining whether the service data is within the data confidence interval after the coordinator receives the service data is similar to that in the embodiment shown in FIG. 1, and details are not repeatedly described herein again.

S330: The node device receives a questioned-data frame sent by the coordinator, where the questioned-data frame carries the service data.

In a case in which the coordinator determines that the service data is beyond the data confidence interval, the coordinator adds the service data to the questioned-data frame, and sends the questioned-data frame to the node device.

S340: The node device confirms correctness of the service data.

After receiving the questioned-data frame sent by the coordinator, the node device confirms whether the service data carried in the questioned-data frame is correct. Specifically:

The confirming, by the node device, correctness of the service data includes:

determining, by the node device by means of comparison, whether the service data in the questioned-data frame is the same as the service data in the data frame sent to the coordinator; and if the service data in the questioned-data frame is different from the service data in the data frame sent to the coordinator, resending the service data to the coordinator; or if the service data in the questioned-data frame is the same as the service data in the data frame sent to the coordinator, verifying, with a service data sensing apparatus, the correctness of the service data.

Specifically, the node device first determines, by means of comparison, whether the service data returned in the questioned-data frame by the coordinator is the same as the service data that has been sent in the data frame to the coordinator by the node device before, and if the service data returned in the questioned-data frame by the coordinator is different from the service data that has been sent in the data frame to the coordinator by the node device before, an error may be caused to the service data in a process of data transmission between the node device and the coordinator. In the situation, the node device may return a data questioning rejected confirmation frame to the coordinator, so as to notify the coordinator that the service data transmitted through the data frame is correct, and then, resend, to the coordinator, the service data that has been transmitted through the data frame before; the node device may directly add the service data in the data frame to a data questioning rejected confirmation frame, and send the data questioning rejected confirmation frame to the coordinator again; or the node device may not send a data questioning rejected confirmation frame to the coordinator, but directly sends, to the coordinator, the service data that has been transmitted through the data frame before. In this embodiment of the present invention, no limitation is imposed on a manner of resending the service data to the coordinator.

If the service data that is questioned and is received by the node device is consistent with the service data that has been sent through the data frame to the coordinator by the node device before, the node device may further verify, with the service data sensing apparatus, the correctness of the service data. For example, whether service data read by the service data sensing apparatus is correct is confirmed by using an application layer. If it is verified that the service data is erroneous, the node device may send a data questioning accepted confirmation frame to the coordinator, and send, to the coordinator, an updated data frame including updated service data.

According to the data processing method provided in this embodiment, a coordinator may determine a data confidence interval of service data dynamically according to historical data, determine whether the service data is within the data confidence interval, and if the service data is beyond the data confidence interval, return the service data to a node device for confirmation. Compared with a manner in the prior art in which a coordinator directly accepts service data, the data processing method provided in this embodiment of the present invention meets requirements of a system on data reliability and accuracy.

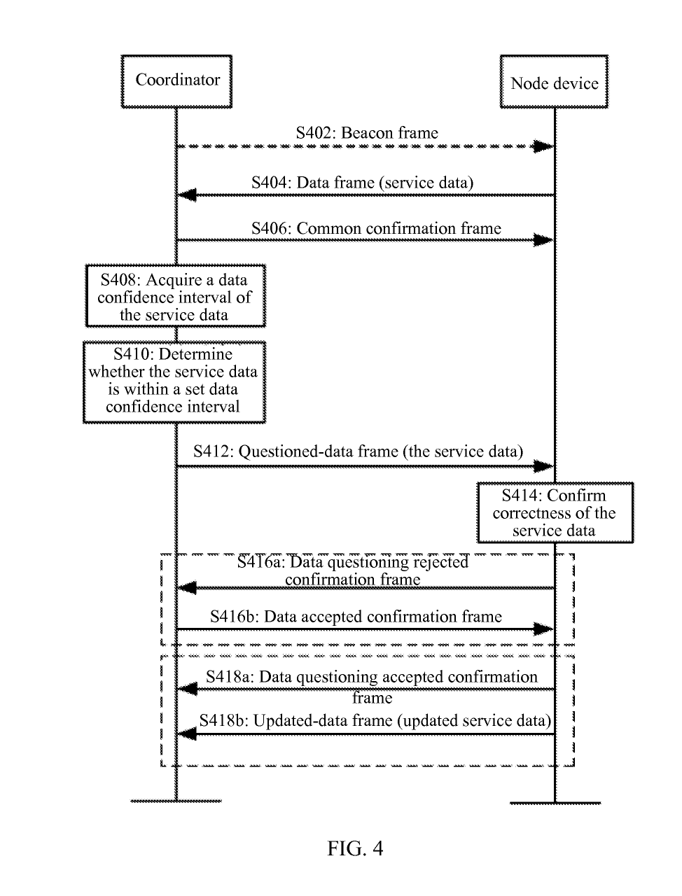

FIG. 4 is a signaling flowchart of Embodiment 4 of a data processing method according to the present invention. As shown in FIG. 4, the data processing method provided in this embodiment of the present invention is described by means of signaling interaction between a coordinator and a node device. The data processing method in this embodiment may include:

S402: Optionally, a coordinator may first send a beacon frame to a node device, so as to instruct the node device to send service data by using a superframe corresponding to the beacon frame.

S404: The node device sends a data frame to the coordinator, where the data frame includes the service data, the service data specifically may be data on household water consumption, household power consumption, or the like, and the service data may be acquired and provided for the node device by a data sensing apparatus.

S406: The coordinator returns a common confirmation frame to the node device to confirm that the data frame has been received.

It should be noted that, the data frame in S404 may be marked as a charging data frame, where the charging data frame includes charging service data; and because requirements of a charging service on transmission reliability and accuracy of the charging service data are higher than those of a common service, the coordinator may proceed with a subsequent step only after receiving the charging data frame, thereby reducing signaling overheads of a system.

S408: Acquire a data confidence interval of the service data. A specific method is similar to that in the embodiment shown in FIG. 1, and details are not repeatedly described.

S410: The coordinator determines whether the service data is within the set data confidence interval.

S412: If the coordinator determines that the service data is beyond the data confidence interval, the coordinator sends a questioned-data frame to the node device, where the questioned-data frame carries the service data.

S414: The node device confirms correctness of the service data.

S416a: The node device sends a data questioning rejected confirmation frame to the coordinator if the node device confirms that the service data is correct.

S416b: The coordinator confirms acceptance of the service data, and sends a data accepted confirmation frame to the node device.

S418a: The node device sends a data questioning accepted confirmation frame to the coordinator if the node device confirms that the service data is erroneous.

S418b: The node device sends an updated data frame to the coordinator, where the updated data frame includes updated service data.

It should be noted that, the data frames and the confirmation frames in this embodiment of the present invention all may be achieved by modifying a format of an existing data frame and a format of an existing confirmation frame. For example, the following may be separately acquired by modifying a data frame type field value in a frame control field of an existing data frame: “a non-charging data frame” (the data frame type field value may be set to 00), “a charging data frame” (the data frame type field value may be set to 01), “a questioned-data frame” (the data frame type field value may be set to 10), and “an updated data frame” (the data frame type field value may be set to 11). The following may be separately acquired by modifying a confirmation frame type field value in a frame control field of an existing confirmation frame: “a common confirmation frame” (the confirmation frame type field value may be set to 00), “a data accepted confirmation frame” (the confirmation frame type field value may be set to 01), “a data questioning rejected confirmation frame” (the confirmation frame type field value may be set to 10), and “a data questioning accepted confirmation frame” (the confirmation frame type field value may be set to 11). No limitation is imposed on forms of the data frames and forms of the confirmation frames in this embodiment of the present invention.

According to the data processing method provided in this embodiment, a coordinator may determine a data confidence interval of service data dynamically according to historical data, determine whether the service data is within the data confidence interval, and if the service data is beyond the data confidence interval, return the service data to a node device for confirmation. Compared with a manner in the prior art in which a coordinator directly accepts service data, the data processing method provided in this embodiment of the present invention meets requirements of a system on data reliability and accuracy.

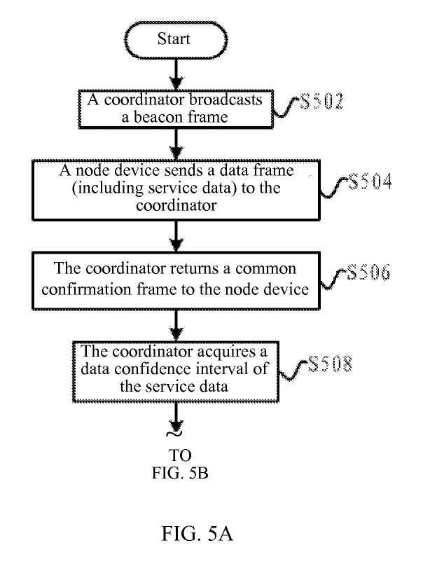

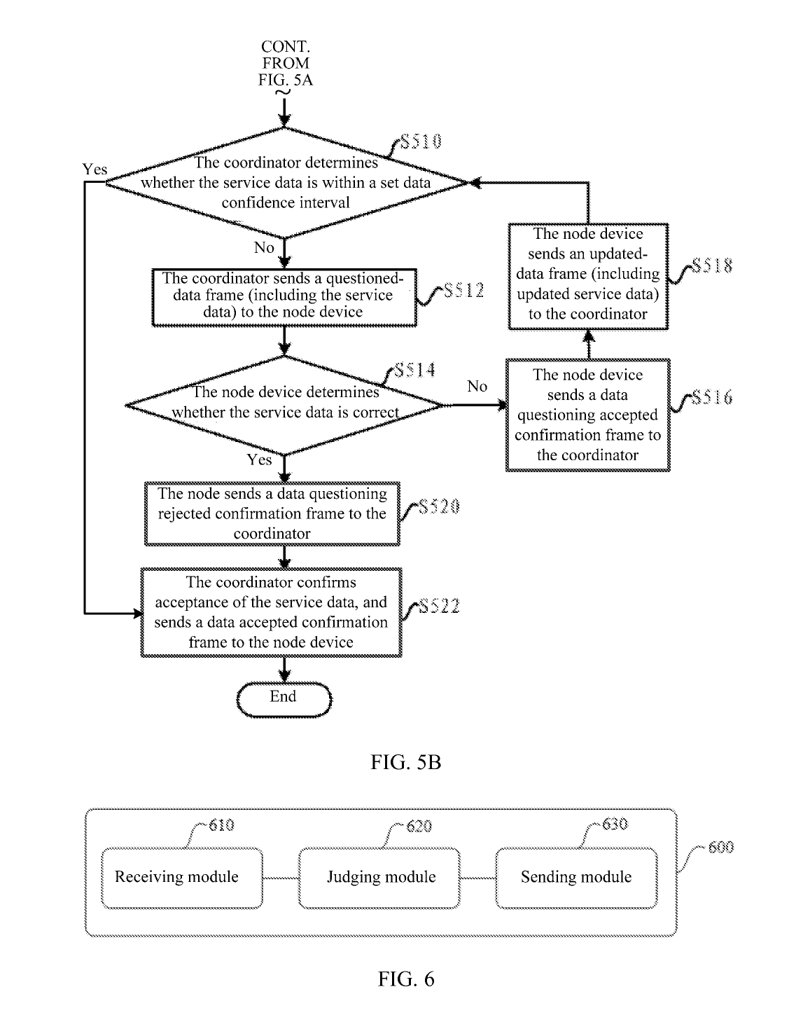

FIG. 5A and FIG. 5B are an overall flowchart of Embodiment 5 of a data processing method according to the present invention. As shown in FIG. 5A and FIG. 5B, the data processing method in this embodiment may include:

S502: Optionally, a coordinator broadcasts a beacon frame, so as to instruct a node device to send service data by using a superframe corresponding to the beacon frame.

S504: The node device sends a data frame to the coordinator, where the data frame includes the service data, the service data specifically may be data on household water consumption, household power consumption, or the like, and the service data may be acquired and provided for the node device by a data sensing apparatus.

S506: The coordinator returns a common confirmation frame to the node device to confirm that the data frame has been received.

It should be noted that, the data frame in S504 may be marked as a charging data frame, where the charging data frame includes charging service data; and because requirements of a charging service on transmission reliability and accuracy of the charging service data are higher than those of a common service, the coordinator may proceed with a subsequent step only after receiving the charging data frame, thereby reducing signaling overheads of a system.

S508: The coordinator acquires a data confidence interval of the service data. A specific method is similar to that in the embodiment shown in FIG. 1, and details are not repeatedly described.

S510: The coordinator determines whether the service data is within a set data confidence interval; and if yes, performs S522, or if not, performs S512.

S512: The coordinator sends a questioned-data frame to the node device, where the questioned-data frame carries the service data.

S514: The node device determines whether the service data is correct; and if the service data is correct, performs S520, or if the service data is erroneous, performs S516.

S516: The node device sends a data questioning accepted confirmation frame to the coordinator.

S518: The node device sends an updated data frame to the coordinator, where the updated data frame includes updated service data.

S520: The node device sends a data questioning rejected confirmation frame to the coordinator in the step when the node device determines, in S514, that the service data is correct.

S522: The coordinator confirms acceptance of the service data, and sends a data accepted confirmation frame to the node device.

According to the data processing method provided in this embodiment, a coordinator may determine a data confidence interval of service data dynamically according to historical data, determine whether the service data is within the data confidence interval, and if the service data is beyond the data confidence interval, return the service data to a node device for confirmation. Compared with a manner in the prior art in which a coordinator directly accepts service data, the data processing method provided in this embodiment of the present invention meets requirements of a system on data reliability and accuracy.

FIG. 6 is a schematic structural diagram of Embodiment 1 of a coordinator according to the present invention. As shown in FIG. 6, the coordinator 600 provided in this embodiment may include: a receiving module 610, a judging module 620, and a sending module 630.

The receiving module 610 is configured to receive a data frame sent by a node device, where the data frame includes service data.

The judging module 620 is configured to determine whether the service data is within a set data confidence interval.

The sending module 630 is configured to send, after the judging module 620 determines that the service data is beyond the data confidence interval, a questioned-data frame to the node device, where the questioned-data frame carries the service data, so that the node device confirms correctness of the service data.

The coordinator 600 provided in this embodiment may be configured to execute the technical solution of the method embodiment shown in FIG. 1. An implementation principle and a technical effect of the coordinator 600 are similar to those of the technical solution, and details are not repeatedly described herein again.

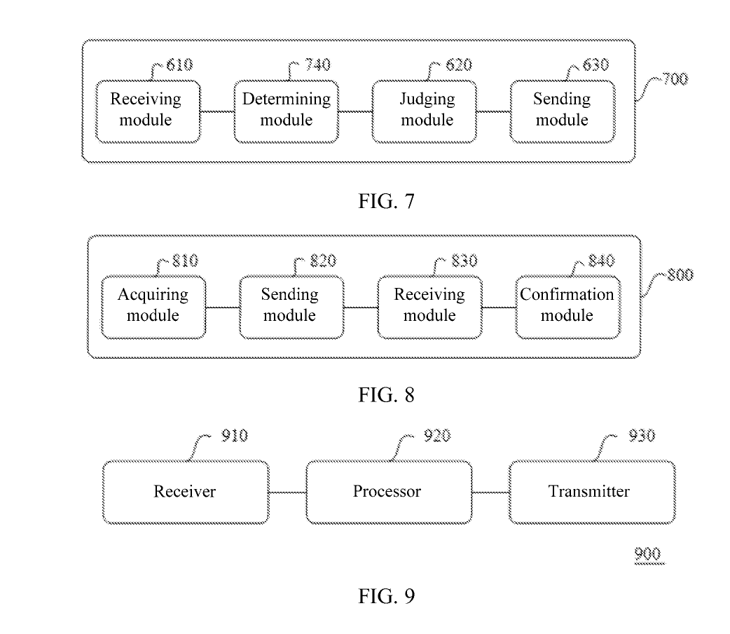

FIG. 7 is a schematic structural diagram of Embodiment 2 of a coordinator according to the present invention. As shown in FIG. 7, based on the embodiment shown in FIG. 6, the coordinator 700 provided in this embodiment may further include a determining module 740.

The determining module 740 is configured to determine the data confidence interval according to historical data having a service type the same as a service type of the service data.

Further, the determining module 740 is specifically configured to: extract multiple pieces of historical data, corresponding to a transmission moment in a transmission cycle in which the service data is, within multiple historical transmission cycles preceding the transmission cycle in which the service data is; and determine the data confidence interval according to [X−a×σ,X+a×σ], where X is a mean of the multiple pieces of historical data, σ is a standard deviation of the multiple pieces of historical data, and a is a tolerance coefficient.

Further, the receiving module 610 is further configured to: receive a data questioning rejected confirmation frame sent by the node device, where the data questioning rejected confirmation frame is used for indicating that the service data is correct; or receive a data questioning accepted confirmation frame sent by the node device, where the data questioning accepted confirmation frame is used for indicating that the service data is erroneous; and receive, an updated data frame sent by the node device, where the updated data frame includes updated service data.

The coordinator 700 provided in this embodiment may be configured to execute the technical solution of the method embodiment shown in FIG. 2, and may also be configured to execute the solution that is executed on a coordinator side and is in the method embodiment shown in FIG. 4, or FIG. 5A and FIG. 5B. An implementation principle and a technical effect of the coordinator 700 are similar to those of the technical solution, and details are not repeatedly described herein again.

FIG. 8 is a schematic structural diagram of Embodiment 1 of a node device according to the present invention. As shown in FIG. 8, the node device 800 provided in this embodiment may include: an acquiring module 810, a sending module 820, a receiving module 830, and a confirmation module 840.

The acquiring module 810 is configured to acquire service data.

The sending module 820 is configured to send a data frame to a coordinator, where the data frame includes the service data, so that the coordinator determines whether the service data is within a data confidence interval.

The receiving module 830 is configured to receive a questioned-data frame sent by the coordinator, where the questioned-data frame carries the service data.

The confirmation module 840 is configured to confirm correctness of the service data.

Further, the confirmation module 840 is specifically configured to: determine, by means of comparison, whether the service data in the questioned-data frame is the same as the service data in the data frame sent to the coordinator; and if the service data in the questioned-data frame is different from the service data in the data frame sent to the coordinator, resend the service data to the coordinator; or if the service data in the questioned-data frame is the same as the service data in the data frame sent to the coordinator, verify, with a service data sensing apparatus, the correctness of the service data.

The node device 800 provided in this embodiment may be configured to execute the technical solution of the method embodiment shown in FIG. 3, and may also be configured to execute the solution that is executed on a node device side and is in the method embodiment shown in FIG. 4, or FIG. 5A and FIG. 5B. An implementation principle and a technical effect of the node device 800 are similar to those of the technical solution, and details are not repeatedly described herein again.

FIG. 9 is a schematic structural diagram of Embodiment 3 of a coordinator according to the present invention. As shown in FIG. 9, the coordinator 900 provided in this embodiment may include: a receiver 910, a processor 920, and a transmitter 930.

The receiver 910 is configured to receive a data frame sent by a node device, where the data frame includes service data.

The processor 920 is configured to determine whether the service data is within a set data confidence interval.

The transmitter 930 is configured to send, after the processor 920 determines that the service data is beyond a data confidence interval, a questioned-data frame to the node device, where the questioned-data frame carries the service data, so that the node device confirms correctness of the service data.

Further, the processor 920 is further configured to determine the data confidence interval according to historical data having a service type the same as a service type of the service data.

Further, the processor 920 is specifically configured to: extract multiple pieces of historical data, corresponding to a transmission moment in a transmission cycle in which the service data is, within multiple historical transmission cycles preceding the transmission cycle in which the service data is; and determine the data confidence interval according to [X−a×σ,X+a×σ], where X is a mean of the multiple pieces of historical data, σ is a standard deviation of the multiple pieces of historical data, and a is a tolerance coefficient.

Further, the receiver 910 is further configured to: receive a data questioning rejected confirmation frame sent by the node device, where the data questioning rejected confirmation frame is used for indicating that the service data is correct; or receive a data questioning accepted confirmation frame sent by the node device, where the data questioning accepted confirmation frame is used for indicating that the service data is erroneous; and receive, an updated data frame sent by the node device, where the updated data frame includes updated service data.

The coordinator 900 provided in this embodiment may be configured to execute the technical solution of the method embodiment shown in FIG. 1 or FIG. 2, and may also be configured to execute the solution that is executed on a coordinator side and is in the method embodiment shown in FIG. 4, or FIG. 5A and FIG. 5B. An implementation principle and a technical effect of the coordinator 900 are similar to those of the technical solution, and details are not repeatedly described herein again.

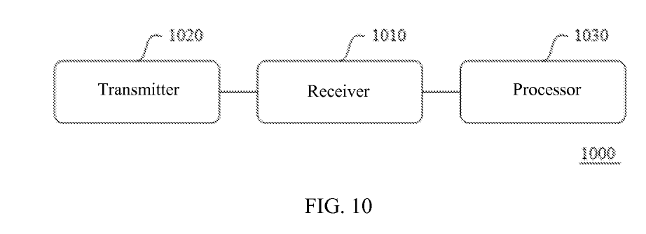

FIG. 10 is a schematic structural diagram of Embodiment 2 of a node device according to the present invention. As shown in FIG. 10, the node device 1000 provided in this embodiment may include: a receiver 1010, a transmitter 1020, and a processor 1030.

The receiver 1010 is configured to acquire service data.

The transmitter 1020 is configured to send a data frame to a coordinator, where the data frame includes the service data, so that the coordinator determines whether the service data is within a data confidence interval.

The receiver 1010 is further configured to receive a questioned-data frame sent by the coordinator, where the questioned-data frame carries the service data.

The processor 1030 is configured to confirm correctness of the service data.

Further, the processor 1030 is specifically configured to: determine, by means of comparison, whether the service data in the questioned-data frame is the same as the service data in the data frame sent to the coordinator; and if the service data in the questioned-data frame is different from the service data in the data frame sent to the coordinator, resend the service data to the coordinator; or if the service data in the questioned-data frame is the same as the service data in the data frame sent to the coordinator, verify, with a service data sensing apparatus, the correctness of the service data.

The node device 1000 provided in this embodiment may be configured to execute the technical solution of the method embodiment shown in FIG. 3, and may also be configured to execute the solution that is executed on a node device side and is in the method embodiment shown in FIG. 4, or FIG. 5A and FIG. 5B. An implementation principle and a technical effect of the node device 1000 are similar to those of the technical solution, and details are not repeatedly described herein again.

According to the embodiments of the present invention, in an actual application scenario, if a node device has a sufficient data storage capability and a sufficient data processing capability and energy is not excessively limited, it may be chosen, according to a situation, that a coordinator itself determines a data confidence interval of service data by using the foregoing methods, so as to reduce a quantity of times of starting a data retransmission mechanism.

The service data in the embodiments of the present invention is not limited to charging data acquired from “a power meter, a gas meter, or a water meter” either, and may also be service data, provided by a wireless sensor associated with various household electronic devices or a wireless sensor related to environmental monitoring, of various services.

In conclusion, according to the data processing method, the coordinator, and the node device that are provided in the embodiments of the present invention, the coordinator may determine a data confidence interval of service data dynamically according to historical data, determine whether the service data is within the data confidence interval, and if the service data is beyond the data confidence interval, return the service data to a node device for confirmation. Compared with a manner in the prior art in which a coordinator directly accepts service data, the data processing method provided in the embodiments of the present invention meets requirements of a system on data reliability and accuracy. Therefore, with the data accuracy being ensured, the system is prevented from unnecessarily starting retransmission and confirmation mechanisms, so that energy consumption is reduced and channel resources are saved.

Persons of ordinary skill in the art may understand that all or some of the steps of the method embodiments may be implemented by a program instructing relevant hardware. The program may be stored in a computer-readable storage medium. When the program runs, the steps of the method embodiments are performed. The foregoing storage medium includes: any medium that can store program code, such as a ROM, a RAM, a magnetic disk, or an optical disc.

Finally, it should be noted that the foregoing embodiments are merely intended for describing the technical solutions of the present invention, rather than limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, as long as such modifications or replacements do not cause the essence of corresponding technical solutions to depart from the scope of the technical solutions of the embodiments of the present invention.

What is claimed is:

1. A data processing method, comprising:
receiving, by a coordinator, a data frame sent by a node device, wherein the data frame comprises service data;
determining, by the coordinator, whether the service data is within a set data confidence interval; and
if the coordinator determines that the service data is beyond the data confidence interval, sending, by the coordinator, a questioned-data frame to the node device, wherein the questioned-data frame carries the service data, so that the node device confirms correctness of the service data.

2. The method according to claim 1, wherein before the determining, by the coordinator, whether the service data is within a set data confidence interval, the method further comprises:
determining, by the coordinator, the data confidence interval according to historical data having a service type the same as a service type of the service data.

3. The method according to claim 2, wherein the determining, by the coordinator, the data confidence interval according to historical data having a service type the same as a service type of the service data comprises:
extracting, by the coordinator, multiple pieces of historical data, corresponding to a transmission moment in a transmission cycle in which the service data is, within multiple historical transmission cycles preceding the transmission cycle in which the service data is; and
determining, by the coordinator, the data confidence interval according to [X−a×σ,X+a×σ], wherein X is a mean of the multiple pieces of historical data, σ is a standard deviation of the multiple pieces of historical data, and a is a tolerance coefficient.

4. The method according to claim 1, wherein after the sending, by the coordinator, a questioned-data frame to the node device, the method further comprises:
receiving, by the coordinator, a data questioning rejected confirmation frame sent by the node device, wherein the data questioning rejected confirmation frame is used for indicating that the service data is correct; or
receiving, by the coordinator, a data questioning accepted confirmation frame sent by the node device, wherein the data questioning accepted confirmation frame is used for indicating that the service data is erroneous; and receiving, by the coordinator, an updated data frame sent by the node device, wherein the updated data frame comprises updated service data.

5. A data processing method, comprising:
acquiring, by a node device, service data;
sending, by the node device, a data frame to a coordinator, wherein the data frame comprises the service data, so that the coordinator determines whether the service data is within a data confidence interval;
receiving, by the node device, a questioned-data frame sent by the coordinator, wherein the questioned-data frame carries the service data; and
confirming, by the node device, correctness of the service data.

6. The method according to claim 5, wherein the confirming, by the node device, correctness of the service data comprises:
determining, by the node device by means of comparison, whether the service data in the questioned-data frame is the same as the service data in the data frame sent to the coordinator; and
if the service data in the questioned-data frame is different from the service data in the data frame sent to the coordinator, resending the service data to the coordinator; or
if the service data in the questioned-data frame is the same as the service data in the data frame sent to the coordinator, verifying, with a service data sensing apparatus, the correctness of the service data.

7. A coordinator, comprising:
a receiving module, configured to receive a data frame sent by a node device, wherein the data frame comprises service data;
a judging module, configured to determine whether the service data is within a set data confidence interval; and
a sending module, configured to send, after the judging module determines that the service data is beyond the data confidence interval, a questioned-data frame to the node device, wherein the questioned-data frame carries the service data, so that the node device confirms correctness of the service data.

8. The coordinator according to claim 7, further comprising:
a determining module, configured to determine the data confidence interval according to historical data having a service type the same as a service type of the service data.

9. The coordinator according to claim 8, wherein the determining module is specifically configured to:
extract multiple pieces of historical data, corresponding to a transmission moment in a transmission cycle in which the service data is, within multiple historical transmission cycles preceding the transmission cycle in which the service data is; and
determine the data confidence interval according to [X−a×σ,X+a×σ], wherein X is a mean of the multiple pieces of historical data, σ is a standard deviation of the multiple pieces of historical data, and a is a tolerance coefficient.

10. The coordinator according to claim 7, wherein the receiving module is further configured to:
receive a data questioning rejected confirmation frame sent by the node device, wherein the data questioning rejected confirmation frame is used for indicating that the service data is correct; or
receive a data questioning accepted confirmation frame sent by the node device, wherein the data questioning accepted confirmation frame is used for indicating that the service data is erroneous; and receive, an updated data frame sent by the node device, wherein the updated data frame comprises updated service data.

11. A node device, comprising:
an acquiring module, configured to acquire service data;
a sending module, configured to send a data frame to a coordinator, wherein the data frame comprises the service data, so that the coordinator determines whether the service data is within a data confidence interval;
a receiving module, configured to receive a questioned-data frame sent by the coordinator, wherein the questioned-data frame carries the service data; and
a confirmation module, configured to confirm correctness of the service data.

12. The node device according to claim 11, wherein the confirmation module is specifically configured to:
determine, by means of comparison, whether the service data in the questioned-data frame is the same as the service data in the data frame sent to the coordinator; and
if the service data in the questioned-data frame is different from the service data in the data frame sent to the coordinator, resend the service data to the coordinator; or
if the service data in the questioned-data frame is the same as the service data in the data frame sent to the coordinator, verify, with a service data sensing apparatus, the correctness of the service data.
